(19) United States
(12) Patent Application Publication
(10) Pub. No.: US 2007/0102095 A1
(43) Pub. Date: May 10, 2007

(54) Method of joining members of a balustrade system

(76) Inventor: Anthony Kastropil, Victoria (AU)

Correspondence Address: D'AMBROSIO & ASSOCIATES, P.L.L.C., 10260 WESTHEIMER, SUITE 465, HOUSTON, TX, 77042, US

(21) Appl. No.: 11/269,316

(22) Filed: Nov. 7, 2005

(51) Int. Cl. B32B 37/00

(52) U.S. Cl. 156/79

(57) ABSTRACT

A method of joining individual rigid members in railings, fencing, balustrading or the like in which the ends of secondary members of smaller diameter are inserted through suitable apertures provided in the walls of primary members of larger diameter into the interiors of the primary members, the interiors then being filled with a suitable foaming polymer material in pressurized liquid form, the foaming polymer material expanding to fill the interiors around the ends of the secondary members and catalyzing to form a solid and more or less rigid foam material with a strong and permanent adhesive attachment to all surfaces.

### FIELD OF THE INVENTION

The present invention relates to a method for joining members within a balustrade system. More particularly, the invention relates to a method of joining primary members to secondary members.

### BACKGROUND OF THE INVENTION

This invention relates to construction systems for the provision of railings, fencing, balustrading or the like. In particular the invention relates to construction systems in which railings, fencing, balustrading or the like are pre-fabricated and installed on-site without the necessity for welding, grinding, polishing and the like.

In the provision of railings, fencing, balustrading or the like, it is common for more or less horizontal railing members to be welded to stanchion members on-site, with the welded parts subsequently being ground smooth and polished. Welded assembly is the most common construction method where components are made from stainless steel, as is the case in many architectural applications. Hand welding of stainless steel is a skilled process which adds to the installed cost of railings or balustradings and frequently results in unsightly local heat distortion of welded components.

Lower cost construction systems in which structural components are simply bolted or clamped together, often using proprietary nodal units, are well known in the art, but these are frequently aesthetically unattractive. As a result, they are unsuited for many architectural applications. Where railing and balustrading construction systems incorporate aesthetically attractive joining means, these usually involve the employment of specially manufactured, expensive components. An example is that taught by U.S. Pat. No. 4,767,232, in which interfitting or mating, joint members are employed to join stanchion and rail members. The joint members are complex in shape, clearly expensive to manufacture, are somewhat limited in the structural arrangements which they permit and, from an aesthetic standpoint, appear somewhat mechanical. A further example which offers a more aesthetically pleasing arrangement is that taught by U.S. Pat. No. 6,568,658. In this arrangement, specially manufactured, shanked fittings are permanently fixed to stanchions with suitable fastenings and the ends of rail members are slipped over the shanks of the fittings. The internal and external diameters, respectively, of the rail members and shanks are such as to provide a neat sliding fit and the ends of the rail members are retained in place on the shanks by the wedging action of O-rings accommodated in suitably shaped, tapered grooves in the shanks.

While this arrangement provides some ease of assembly, in some applications, long-term hardening and deterioration of the O-rings as a result of temperature extremes may be expected with a possible loss of structural integrity. Additionally, where they are required, intermediate vertical rails between upper and lower horizontal rails are still required to be welded into place. The arrangement thus does not properly fill the need for a relatively low cost, easily assembled, permanent structure.

### SUMMARY

The present invention provides a method of constructing railings, fencing, balustrading or the like which employs simple, low-cost, mass-producible nodal components to join railing members to stanchion members. The method provides a joint between the members that is aesthetically pleasing, may be readily assembled on-site without welding or the use of special tools, is readily adaptable to a wide variety of arrangements and has a high and permanent structural integrity.

In one method of joining individual rigid members in railings, fencing, balustrading or the like, the ends of secondary members of smaller diameter are inserted through suitable apertures provided in the walls of primary members of larger diameter into the interiors of the primary members, the interiors then being filled with a suitable foaming polymer material in pressurized liquid form, the foaming polymer material expanding to fill the interiors around the ends of the secondary members and catalyzing to form a solid and more or less rigid foam material with a strong and permanent adhesive attachment to all surfaces

In this method of joining a primary member of a balustrade system with a horizontal member of the balustrade system the primary member can be the vertical member, either an intermediate vertical rail or a stanchion that form an aperture and the secondary member is a horizontal rail that is fitted within the aperture. Alternatively, the primary member can be a horizontal rail member that forms an aperture to receive an intermediate vertical rail member. In either embodiment, an adhesive foam is added into an interior of the primary member. The adhesive foam is allowed to fill the interior of the primary member around the portion of the secondary member that is inserted within it. The adhesive foam is then allowed to solidify and form an adhesive attachment or joint between the primary member and the secondary member.

Another method of joining a primary member of a balustrade system with a secondary member of the balustrade system uses a primary member that is hollow. The method comprises forming an aperture or opening in the hollow primary member and inserting the secondary member into that aperture.

During the method of this invention, the primary member and secondary member are supported in a desired position until the joint is fixed. Plugs are then inserted into a first end and a second end of the primary member. A pressurized liquid is then injected into the primary member through a conduit connection in one of the plugs, the pressurized liquid can comprise an adhesive polyurethane compound foam. The adhesive polyurethane compound foam is allowed to fill the space within the primary member and surround the portion of the secondary member that has been inserted into the primary member. As the adhesive polyurethane compound foam is allowed to solidify, it forms a solid adhesive attachment or joint between the primary member and the secondary member.

In one aspect of the present invention, suitable stanchion members are fixed to a supporting surface at suitable intervals. Intermediate railing assemblies are created by fixing the ends of a plurality of parallel, intermediate rail members to upper and lower horizontal rail members by inserting the ends through apertures provided in the upper and lower horizontal rail members and fixing them in position without the need for welding or the use of fastenings by filling the rail members. The rail members are fixed with a suitable foam material which sets more or less rigidly to provide a strong, adhesive attachment. The intermediate railing assemblies are then fixed to the stanchion members using suitable attachment means.

The various aspects of the present invention will be more readily understood by reference to the following description of preferred embodiments given in relation to the accompanying drawing in which:

### BRIEF DESCRIPTION OF DRAWING

FIG. 1 is a partial longitudinal cross-sectional view of parallel intermediate rail members fixed to a horizontal rail member with a foam material.

### DETAILED DESCRIPTION OF THE PREFERRED EMBODIMENTS

The method of this invention is used to join secondary, horizontal members of a balustrade or railing system to primary, vertical members. The horizontal members can comprise rails and the vertical members can comprise vertical rail members connecting horizontal rail members such as used in intermediate rail assemblies. Alternatively, the vertical members can comprise stanchions. The present method is useful to join any combination of vertical, horizontal or oblique members of a balustrade system with each other to form a railing or fence.

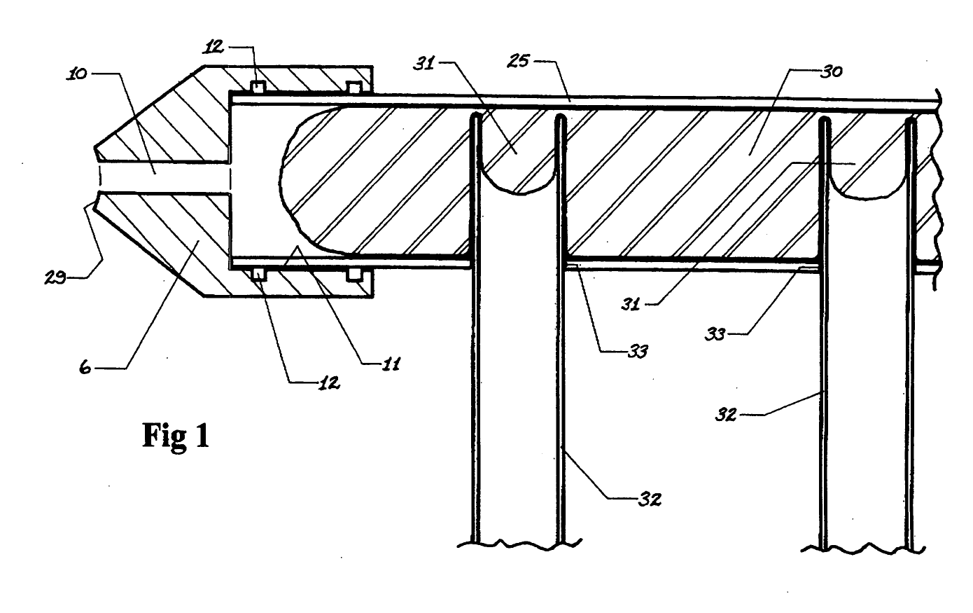

In one embodiment of the present invention as illustrated in FIG. 1, the primary members are horizontal rail members 25 and the secondary members are intermediate vertical rail members 32. The intermediate vertical rail members 32 extend between secondary or upper and lower horizontal rail members 25. The primary members or horizontal members 25 define apertures or openings and are joined to the vertical rail members 32 by inserting the vertical rail member 32 through suitable apertures 33 defined within the horizontal rail members 25. In this embodiment, the apertures can be punched, drilled or cut through the horizontal rail members. The aperture within the horizontal rail member 25 is sized to form a close sliding fit with the vertical rail member 32 when it is inserted within horizontal rail member 25. The ends of the vertical rail members 32 can be cut square and extend into the interior of the horizontal rail members 25 until they abut the opposite interior wall.

In one aspect of this invention, the horizontal and vertical rail members are supported horizontally in suitable elementary jigging means (not shown) in correct and accurate juxtaposition to each other until adhesive foam solidifies and forms the adhesive bond securing the vertical rail member within the horizontal rail member. To achieve this, when the members are supported in place by the jig, an adhesive foam is injected into the interior of the primary or horizontal rail member 25. A measured quantity of an adhesive compound, such as a foaming polymer material 30, is pumped in pressurized liquid form into the horizontal rail members from access points at the ends of the rail members. Prescribed procedures for use of the foaming polymer material are followed to ensure proper catalysis, bond and strength development.

Within the horizontal rail members, the polymer foam material expands to fill every void. When the adhesive foam catalyzes to solidify, it forms a strong and permanent adhesive attachment between all surfaces the foam covers so that, as the adhesive sets, the secondary, vertical member is held within the aperture of the primary horizontal member. The solidified foam forms a strong, adhesive bond joining the primary member and secondary members. It is unnecessary for the flow of the polymer foam material to penetrate the vertical rail members as depicted at 31 as fixing of the vertical rail members is effected by the bond between the external surface 69 of the ends of the vertical rail members and the polymer foam material. Minimal clean-up of the polymer material is necessary and the rail members are retained in the jigging means until the polymer foam material has properly set.

In one embodiment of the method of this invention, the polymer foam material is a polyurethane which sets to a tough, light solid having a strong, adhesive attachment to all surfaces. Suitable plugs incorporating filling conduit connection means are inserted into the ends of any member that is to be filled with the adhesive polymer foam material to facilitate injection of the pressurized liquid form.

The polymer foam material can take the form of any suitable adhesive compound which may be foamed. In this method, the foaming agent can be selected from a chemical foaming agent or physical blowing agent. The adhesive is injected in pressurized liquid form into the interiors of the rail members where it catalyzes and is set in a solid foam form to develop a strong and permanent adhesive attachment to all surfaces.

In the alternative, the polymer foam material may be replaced with any suitable adhesive compound which can be injected in pressurized liquid form into the interiors of the rail members to catalyze, set solid and develop a strong and permanent adhesive attachment to all surfaces thereby forming the joint between the primary member and the secondary member without the need for welding.

After setting of the polymer foam material, the rail member assembly is removed from the jigging means and assembled to stanchion members in the manner described. In the preferred embodiment, the vertical rail members are fixed normal to the horizontal rail members. In alternative embodiments, the vertical rail members are fixed to the horizontal rail members in other angular relationships, the method readily permitting this.

After punching apertures in the horizontal rail members, the rail members and pre-cut, the intermediate vertical rail members are assembled together using suitable jigging means. In the preferred embodiment, the jigging means comprise two pairs of superimposed parallel jigging rails. The pairs of jigging rails are positioned normal to each other with a first, lower pair of suitable lateral separation fixed to a stable base and a second, upper pair of suitable lateral separation fixed to the first pair. Each rail in the second pair has fixed to it a plurality or identically positioned, open, U-shaped jigging fittings into which the intermediate, vertical rail members may be laid in parallel arrangement. Each rail in the first pair has fixed to it a pair of soft jawed clamps, the clamps being positioned at a height such that the horizontal rail members clamped in them will be at the correct height to engage the ends of the intermediate, vertical rail members. The soft-jawed clamps are employed to prevent marring of the horizontal rail members. In operation, the ends of the intermediate, vertical rail members are engaged in the punched apertures of the horizontal rail members, the intermediate, vertical rail members are accommodated within the U-shaped jigging fittings and the horizontal rail members are clamped in the soft-jawed clamps. Prior to tightening of the clamps, care is taken to ensure that the horizontal rail members are correctly positioned to ensure that the centrelines of the intermediate, vertical rail members intersect those of the horizontal rail members. In this position, the horizontal rail members are ready for filling. The U-shaped jigging fittings and the soft-jawed clamps are screwably fixed to suitably spaced, threaded apertures in the rails and are replaced as required where different tube sizes are to be accommodated.

When securely and correctly clamped in the jigging means, the horizontal rail members are ready for filling with an adhesive, preferably, polymer material. In one embodiment, the horizontal rail members are fitted at one end with a suitable plug through which passes a filling fitting. The other ends of the horizontal rail members are left open or are fitted with plugs having small telltale apertures. The delivery hose from a commercial mixing unit is connected in turn to each the filling fitting and a fixed quantity of settable, foaming adhesive material is injected into the interiors of the horizontal rail members. In alternative embodiments, the foaming adhesive material is injected through the filling fittings until a flow is observed through the telltale apertures. In another alternative embodiment, the foaming adhesive material is injected through the filling fittings at a calibrated flow rate for a predetermined period. Commercial mixing units for the generation of a flow of settable, foaming adhesive material are used for a variety of applications. When the settable, foaming adhesive material has set hard in the horizontal rail members, the soft-jawed clamps are released and the assembly of rail members is removed for shipment and installation.

The method of this invention as describe above can also be effective to join horizontal rails to vertical stanchions or posts, wherein the stanchion is the primary member defining an aperture, and the horizontal rail is the secondary member to be fitted within the aperture, or vice versa. Alternatively, as illustrated with above-referenced method of joining intermediate rail assemblies, the primary member can be a horizontally positioned rail and the secondary member can be a vertically positioned rail. Any combination of vertical, horizontal or oblique members of a balustrade system may be used in this method wherein the end of one may be accommodated within the running part of another.

In one aspect of the method of this invention, the method may be employed with rail or stanchion tubing which is round, square, rectangular, fluted or D-shaped in cross-section or of any other regular-polygonal cross-sectional shape.

In another aspect, while the primary member must be substantially hollow to allow for the adhesive foam to form the solid joint, secondary members that will be joined to the primary members through the use of the method may be solid or hollow.

With reference again to FIG. 1, the intermediate railing assemblies comprising the parallel, intermediate rail members fixed to the upper and lower horizontal rail members by the foam material can then be fixed to the stanchion members using suitable attachment means, including the means of attachment as described above. In another embodiment, the attachment means can include a system incorporating (as depicted in FIG. 1) toroido-cylindrical nodal rings (not shown) positioned on the stanchion members, to which are fixed socket fittings 6 having plain bores 11 in which are accommodated and supported the ends of horizontal rail members 25. Threaded bores 10 made collinear with the socket fittings accommodate fastenings connecting the socket fittings to the nodal rings.

1. A method of joining a hollow primary member of a balustrade system with a secondary member of the balustrade system, the method comprising:
inserting the secondary member into an aperture defined by the primary member;
adding an adhesive foam into an interior of the primary member;
allowing the adhesive foam to fill the interior of the primary member around the secondary member; and
allowing the adhesive foam to solidify and form an adhesive attachment between the primary member and the secondary member.

2. The method of claim 1 wherein the primary and secondary members are maintained in correct juxtaposition until the foaming adhesive has catalyzed to form a solid and substantially rigid foam material with a strong and permanent adhesive attachment to all surfaces.

3. The method of claim 1 wherein the aperture is sized to form a close sliding fit with the secondary member.

4. The method of claim 1 wherein the method further comprises cutting the aperture in the primary member.

5. The method of claim 1 wherein the method further comprises drilling the aperture in the primary member.

6. The method of claim 1 wherein the method further comprises punching the aperture in the primary member.

7. The method of claim 1 wherein the step of adding an adhesive foam comprises injecting the adhesive compound in the form of a pressurized liquid into the interior of the primary member.

8. The method of claim 1 wherein the method further comprises inserting a plug into a first end of the primary member and inserting a plug into a second end of the primary member.

9. The method of claim 8 wherein the adhesive foam is added to the primary member by injecting the adhesive foam in a pressurized liquid form through a conduit connection in one of the plugs.

10. The method of claim 1 wherein a chemical foaming agent is used to make the adhesive foam.

11. The method of claim 1 wherein in a physical blowing agent is used to make the adhesive foam.

12. The method of claim 1 wherein the adhesive foam is polymer foam.

13. The method of claim 12 wherein the polymer foam is a polyurethane compound.

14. The method of claim 1 wherein the primary member is a stanchion and the secondary member is a rail.

15. The method of claim 1 wherein primary member is a horizontal rail member and the secondary member is an intermediate vertical rail member.

16. The method of claim 1 wherein the cross-sectional shape of the primary member is round, rectangular, square, fluted, D-shaped, or polygon shaped and the cross-sectional shape of the secondary member is round, rectangular, square, fluted, D-shaped, or polygon shaped.

17. The method of claim 1 wherein the method further comprises supporting the primary member and secondary member in desired position until the adhesive foam solidifies and forms an adhesive bond joining the primary member and secondary members.

18. The method of claim 17 wherein a jig is used to support the primary member and secondary member.

19. The method of claim 1 wherein the primary member is a horizontally-positioned rail and the secondary member is vertically-positioned rail.

20. A method of joining a hollow primary member of a balustrade system with a secondary member of the balustrade system, the method comprising:
forming an aperture in a hollow primary member;
inserting a secondary member into the aperture;
supporting the primary member and secondary member in a desired position;
inserting a plug into a first end of the primary member;
inserting a plug into a second end of the primary member;
injecting an pressurized liquid into the primary member through a conduit connection in one of the plugs, the pressurized liquid comprising an adhesive polyurethane compound foam;
allowing the adhesive polyurethane compound foam to fill the primary member around the secondary member; and
allowing the adhesive polyurethane compound foam to form a solid with adhesive attachments to the primary member and the secondary member.
